(19) United States
(12) Patent Application Publication
(10) Pub. No.: US 2019/0259168 A1
(43) Pub. Date: Aug. 22, 2019

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Yukichika Ichihashi, Kashiwa-shi (JP)

(21) Appl. No.: 16/269,684

(22) Filed: Feb. 7, 2019

(30) Foreign Application Priority Data
Feb. 19, 2018 (JP) 2018-026814

(51) Int. Cl. G06T 7/40; G06T 7/11; G06T 7/90; G06T 5/40; H04N 1/60

(52) U.S. Cl. CPC G06T 7/40; G06T 7/11; H04N 1/6097; G06T 5/40; G06T 7/90

(57) ABSTRACT

An image processing apparatus comprises: a memory device that stores a set of instructions; and at least one processor that executes the set of instructions to: obtain an image; segment the obtained image into regions; and integrate a specular reflected light region and an adjacent region adjacent to the specular reflected light region among the segmented regions into an integrated region; and determine glossiness of each of the regions including the integrated region.

### BACKGROUND OF THE INVENTION

### Field of the Invention

The present invention relates to a technique of image processing for controlling glossiness.

### Description of the Related Art

Recently, texture and glossiness are desired to be expressed in addition to colors and gradation in print images printed by image processing apparatuses such as multi-function peripherals and printers. As a gloss determination method of determining whether an object in an image is glossy or not, there is a method described in “Image statistics and the perception of surface qualities”, Nature, 447, 206-209, (2007) (hereafter, referred to as Document 1).

Document 1 discloses that there is a high correlation between the skewness of a lightness histogram and perceived gloss and brightness, by using psychophysical experiments. More specifically, Document 1 states that, for example, the higher the gloss on a surface of an image is, the more the lightness histogram is positively skewed (the frequency of appearance of pixels corresponding to each level of lightness gradually increases toward high lightness). Accordingly, it is possible to evaluate the degree of gloss of a surface in an image based on the skewness of the lightness histogram. The skewness of the lightness histogram is based on a dichromatic reflection model. The dichromatic reflection model is a model in which two types of reflected light of specular reflected light and diffuse-reflected light are generated in the case where light from a light source is casted on a surface of an object. The specular reflected light is light emitted from a light source illuminating a glossy object and directly reflected on the object and is a factor which determines a gloss portion in the image. The diffuse-reflected light is light reflected while being affected by the light source and the surface characteristics and color of the object and is a factor which determines the color and texture in the image.

Document 1 states that humans tend to perceive a certain degree of gloss in the case where the lightness histogram expressed as a result of the specular reflected light and the diffuse-reflected light has positive skewness (degree of skewness). In order to determine the degree of gloss by using the method described in Document 1, an object region with a certain degree of gloss needs to be specified from a photographic image. This is because the degree of gloss varies depending on the material, shape, and the like of each object. In other words, the dichromatic reflection model varies depending on the object.

As a method of segmenting an object region, there is a method of performing region segmentation based on values of pixels. “SLIC Superpixels Compared to State-of-the-art Superpixel Method” IEEE Pattern and machine intelligence, 2274-2282 (2012-11) (hereafter, referred to as Document 2) discloses region segmentation processing called SLIC as a method of segmenting an object region. In the SLIC processing, pixels are grouped depending on the coordinate distance between the pixels and the distance between the pixels in the CIE L*a*b* space. It is possible to determine the object region in the image by employing such region segmentation processing and then determine whether the object region is glossy or not by using the method of Document 1.

However, in the case where the region segmentation is performed based on the values of pixels, the object region is sometimes segmented into a region of the specular reflected light and a region of the diffuse-reflected light which are separate object regions although they belong to the same object. This is because the pixel values (or lightness values obtained by converting the pixel values) greatly vary between the specular reflected light and the diffuse-reflected light. Accordingly, in the case where the processing of determining the glossiness is performed in consideration of the dichromatic reflection model as in the method described in Document 1, appropriate results cannot be sometimes obtained.

### SUMMARY OF THE INVENTION

An image processing apparatus according to one aspect of the present invention comprises: a memory device that stores a set of instructions; and at least one processor that executes the set of instructions to: obtain an image; segment the obtained image into regions; and integrate a specular reflected light region and an adjacent region adjacent to the specular reflected light region among the segmented regions into an integrated region; and determine glossiness of each of the regions including the integrated region.

Further features of the present invention will become apparent from the following description of exemplary embodiments with reference to the attached drawings.

### BRIEF DESCRIPTION OF THE DRAWINGS

FIG. 1 is a view illustrating an example of a system configuration;

FIG. 2 is a view illustrating an example of a configuration of an image processing unit;

FIG. 3 is a flowchart of overall processing;

FIG. 4 is a flowchart of glossiness processing;

FIGS. 5A to 5E are views illustrating an example of region segmentation and region integration;

FIG. 6 is a flowchart of region integration processing;

FIG. 7 is a flowchart of processing of extracting a candidate of a specular reflected light region;

FIG. 8 is a flowchart of determination processing of a flare characteristic;

FIGS. 9A and 9B are explanatory views of the determination processing of the flare characteristic;

FIGS. 10A to 10D are explanatory views of region integration processing;

FIG. 11 is a flowchart of determination processing of the flare characteristic; and

FIGS. 12A and 12B are explanatory views of the determination processing of the flare characteristic.

### DESCRIPTION OF THE EMBODIMENTS

Embodiments of the present invention are described below by using the drawings. Note that the following embodiments do not limit the invention according to the scope of claims and not all of the combinations of characteristics described in the embodiments are necessary for means of solving the problems in the invention.

### Embodiment 1

<System Configuration>

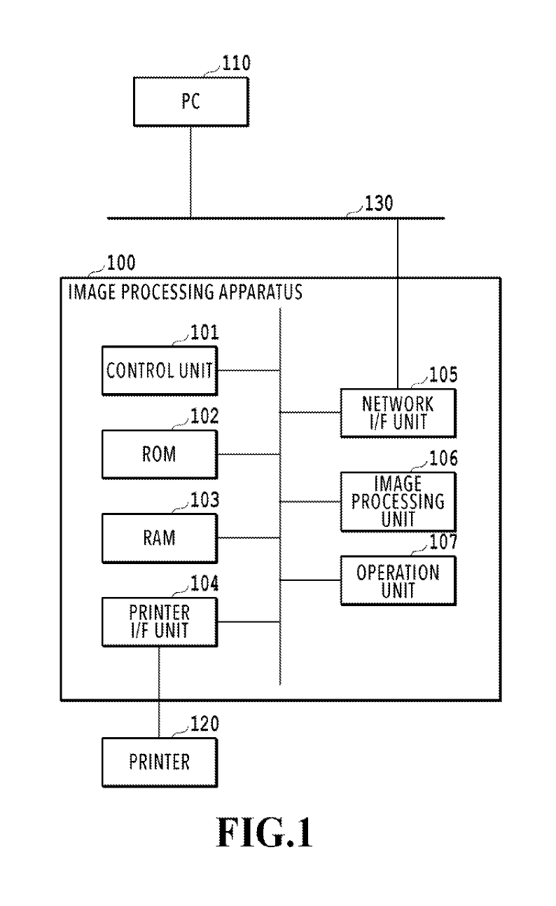

FIG. 1 is a configuration example of a print system in Embodiment 1. The print system includes an image processing apparatus 100, a personal computer (PC) 110, and a printer 120.

The image processing apparatus 100 includes a control unit 101, a ROM 102, a RAM 103, a printer I/F unit 104, a network I/F unit 105, an image processing unit 106, and an operation unit 107. The image processing apparatus 100 is connected to the printer 120 via the printer I/F unit 104. The image processing apparatus 100 is connected to a network 130 via the network I/F unit 105. The image processing apparatus 100 is capable of exchanging data with the PC 110 via the network 130.

The control unit 101 is formed of, for example, a CPU, and performs various types of control for the image processing apparatus 100. The ROM 102 stores programs and the like used to execute predetermined processing. The RAM 103 is used to temporarily store data. The image processing unit 106 performs various types of image processing based on print data sent from the PC 110. In the embodiment, the PC 110 sends print description language (PDL) data to the image processing unit 106 and the image processing unit 106 performs processing on the PDL data. The operation unit 107 receives inputs from outside. The processing described hereafter is described as processing performed mainly by the image processing unit 106. Note that it is possible to employ a mode in which the control unit 101 performs the various types of image processing according to the programs stored in the ROM 102 while using the RAM 103. In other words, the control unit 101 may function as the image processing unit 106. Moreover, the image processing unit 106 may have a special computation circuit for achieving high-speed processing. In this case, the processing described below may be executed by the image processing unit 106 alone or be distributed between the control unit 101 and the image processing unit 106.

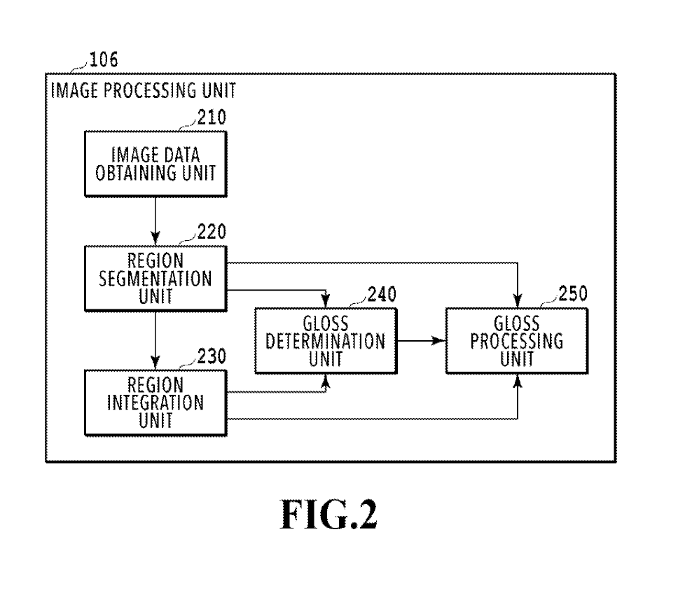

FIG. 2 is a view illustrating an example of the configuration of the image processing unit 106. The image processing unit 106 includes an image data obtaining unit 210, a region segmentation unit 220, a region integration unit 230, a gloss determination unit 240, and a gloss processing unit 250. Note that the image processing unit 106 may include one or multiple pieces of dedicated hardware or a graphics processing unit (GPU) which is separate from the CPU forming the control unit and be configured such that the GPU or the dedicated hardware performs at least part of the processing. Examples of the dedicated hardware include an application specific integrated circuit (ASIC), a digital signal processor (DSP), and the like. Moreover, part of the processing of the image processing unit 106 may be performed by the control unit 101.

The image data obtaining unit 210 obtains image data. The region segmentation unit 220 performs processing of segmenting an image corresponding to the image data obtained by the image data obtaining unit 210 into regions. Details are described later. The region integration unit 230 performs processing of integrating certain regions among regions obtained by the segmentation by the region segmentation unit 220. Details are described later. The gloss determination unit 240 performs gloss determination processing on each of the regions including the regions integrated by the region integration unit 230. For example, the gloss determination unit 240 determines whether each region is glossy or not based on the skewness of the lightness in the image as described in the aforementioned Document 1. The gloss processing unit 250 performs image processing relating to gloss based on results of the determination by the gloss determination unit 240.

### <Overall Processing>

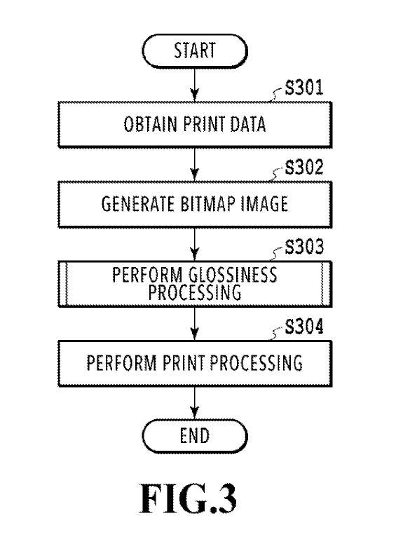

FIG. 3 is a flowchart illustrating a flow of overall processing. In step S301, the control unit 101 obtains the print data received from the PC 110. The print data is, for example, the PDL data. In step S302, the control unit 101 interprets the PDL data and generates a bitmap image. The PDL data includes images such as photographic images, rendering data of graphics, and the like. The control unit 101 interprets the PDL data and generates a color bitmap image including pixel values of RGB. The generated bitmap image is temporarily stored in the RAM 103. A mode in which the image processing unit 106 generates the bitmap image may be employed. Note that, for the sake of description, the bitmap image in the embodiment is assumed to an image of a photograph capturing a certain object.

In step S303, the image processing unit 106 performs the processing relating to glossiness. For example, the image processing unit 106 specifies a gloss region which is glossy in the image and performs predetermined image processing on the gloss region. In the embodiment, certain regions are integrated and then the determination of whether each region has glossiness is performed. Details are described later.

In step S304, the control unit 101 performs the print processing by using the image data subjected to the image processing in step S303.

### <Glossiness Processing>

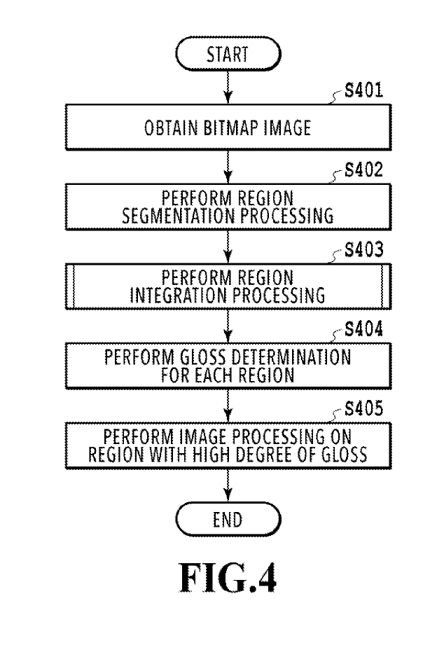

FIG. 4 is a flowchart for explaining details of the glossiness processing in step S303 of FIG. 3. In step S401, the image data obtaining unit 210 obtains the bitmap image.

In step S402, the region segmentation unit 220 performs region segmentation processing on the bitmap image. In the embodiment, a mode of using the SLIC processing described in Document 2 is explained as an example. Note that other region segmentation methods may be used. In the SLIC processing, the image is segmented into multiple regions (hereafter, also referred to as clusters). Specifically, a region (cluster) in which each pixel in the image belongs is determined depending on the color difference between the pixel and a pixel located at the center of the cluster in the CIE L*a*b* space and on the distance from coordinates where the center of the cluster is located to coordinates of the pixel.

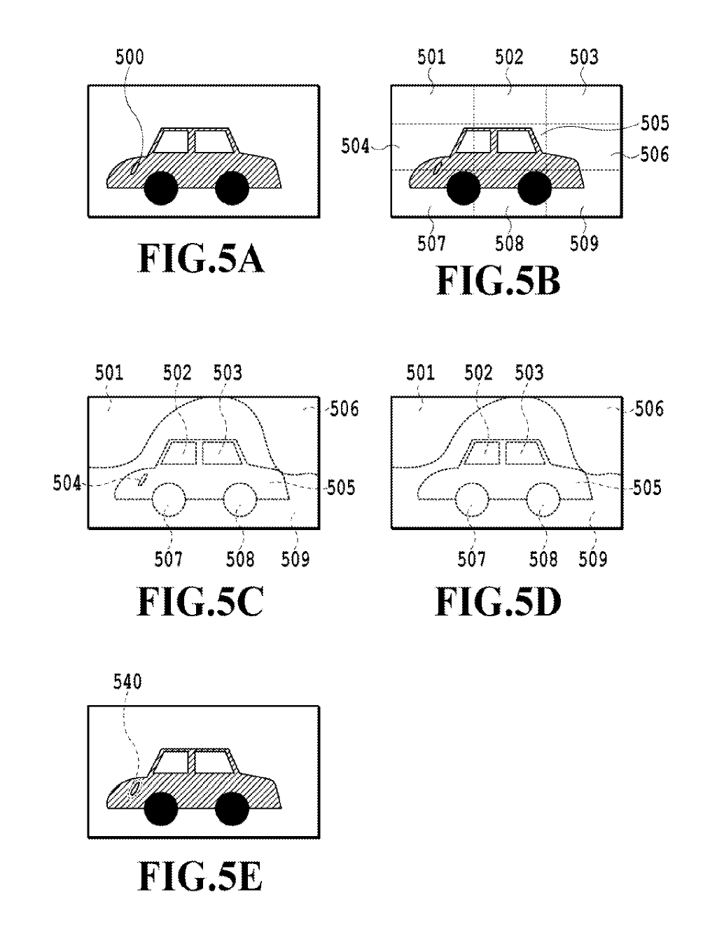

FIGS. 5A to 5E are views illustrating a specific example. FIG. 5A illustrates an example of the bitmap image. FIG. 5A schematically illustrates an image of a photograph of a car. In a portion of a vehicle body on the left side in FIG. 5A, there is a region 500 including light of a light source which is specular reflected light. FIGS. 5B and 5C are views for explaining an example in which the region segmentation processing is performed on the image illustrated in FIG. 5A. FIG. 5B illustrates a result of region segmentation in an initial state. In this case, the image is segmented equally into regions which are assigned as clusters 501 to 509. The broken lines in FIG. 5B illustrate borders of the regions. FIG. 5C illustrates an example of a result of region segmentation performed by means of the SLIC processing. In a case where processing of changing the clusters from the initial segmentation state in FIG. 5B depending on the color difference and distance between each pixel and the center of the cluster, a segmentation state as illustrated in FIG. 5C is obtained. Note that the number of segmentation regions does not have to match the number of segmentation regions in the initial state.

The clusters relating to gloss in FIG. 5C are the cluster 504 and the cluster 505. The cluster 505 has a color of an object in the bitmap image and is a region of diffuse-reflected light. Meanwhile, the cluster 504 has a color of the light source and is a region of specular reflected light. In a case where a normal photograph is bitmapped, the cluster 504 is brighter than the cluster 505 from a viewpoint of a dichromatic reflection model. Moreover, the values of CIE L*a*b* greatly vary between the cluster 505 and the cluster 504. Accordingly, in the result of the region segmentation processing, the clusters 505 and 504 are processed as separate clusters as in FIG. 5C. The cluster 504 and the cluster 505 are both actually regions of the same object which is the vehicle body. Accordingly, it is preferable to determine a region obtained by integrating these clusters as an object region and perform processing of determining the degree of gloss on this object region. This is because, in the case where the cluster 504 and the cluster 505 are handled as regions of separate objects, an appropriate determination result cannot be obtained in the processing of determining the degree of gloss performed later. Thus, region integration processing is performed in the embodiment.

In step S403, the region integration unit 230 performs the processing of integrating the regions obtained by the segmentation in step S402. This processing is explained by using the example of FIG. 5C. The cluster 505 and the cluster 504 are originally regions of the same object. Accordingly, as illustrated in FIG. 5D, processing of integrating the clusters 504 and the cluster 505 to form one region is performed. Details of the integration processing are described later.

In step S404, the gloss determination unit 240 performs the gloss determination processing for each of the regions including the region integrated as a result of the integration processing in step S403. Specifically, the gloss determination unit 240 performs the gloss determination processing for each of the regions in FIG. 5D. The gloss determination unit 240 generates a lightness histogram for each region and obtains the skewness of the lightness in the region. In a case where the skewness is positive, the gloss determination unit 240 can determine that the region is glossy. Refer to Document 1 for details.

In step S405, the gloss processing unit 250 performs gloss image processing on a region with high degree of gloss. For example, the gloss processing unit 250 performs processing of increasing the glossiness by adjusting lightness gradation characteristics of the gloss region or adjusting lightness gradation characteristics of regions other than the gloss region. Alternatively, in the case where the printer 120 is capable of special toner processing by using a clear toner, a gloss toner, or the like, gloss information may be added to the bitmap image to change color conversion in the printing of the gloss region.

### <Region Integration Processing>

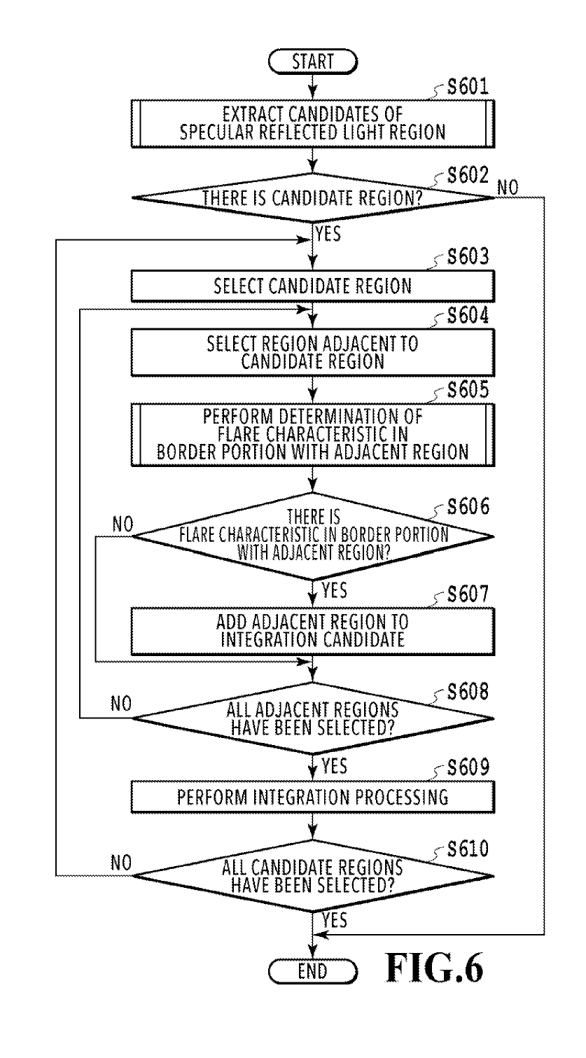

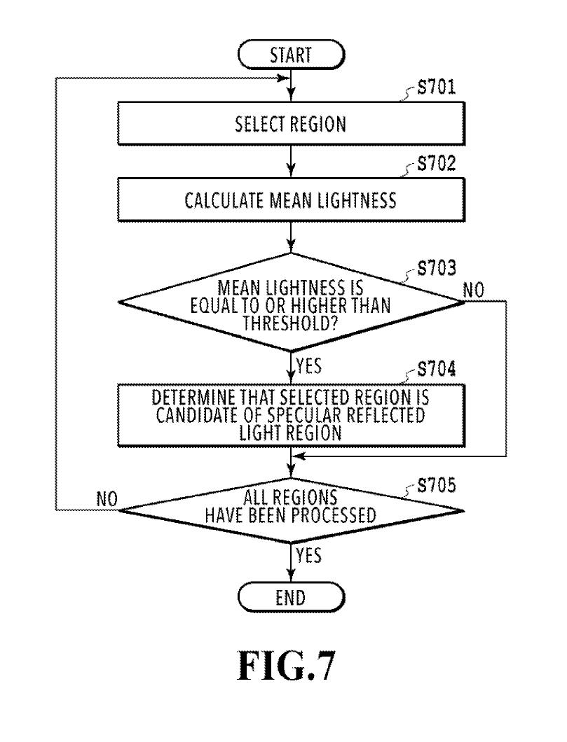

FIG. 6 is a flowchart for explaining details of the region integration processing in step S403 of FIG. 4. In step S601, the region integration unit 230 extracts regions which are candidates of the specular reflected light region, from the clusters 501 to 509 obtained by the segmentation in step S402. Details of step S601 are described by using FIG. 7.

In step S701, the region integration unit 230 selects one of the segmentation regions (clusters 501 to 509). In step S702, the region integration unit 230 converts RGB brightness values in the region selected in step S701 to L* (lightness) in CIE L*a*b* and calculates a mean lightness value of all pixels in the region. Note that the processing may be performed such that values of CIE L*a*b* obtained in color conversion performed in the region segmentation processing are held and the mean lightness value is calculated by using the held values.

In step S703, the region integration unit 230 determines whether the mean lightness value calculated in step S702 is equal to or more than a threshold or not. The specular reflected light region is a region in which the light source is reflected and captured in imaging of the photograph. The specular reflected light region is thus a region with the highest degree of lightness. Accordingly, the threshold is determined based on the highest degree of lightness in the entire photograph (bitmap image). For example, the threshold is determined according to the following formula 1.

threshold=α×L max (Formula 1)

In this formula, α is a certain positive value which is 1.0 or less. Lmax is the highest degree of lightness in the entire bitmap image. α in the formula (1) is a value used to determine a percentage of error allowed relative to the highest degree of lightness. A value determined in advance can be used as α.

In a case where the mean lightness value is equal to or more than the aforementioned threshold, the processing proceeds to step S704. If not, step S704 is skipped and the processing proceeds to step S705. If the mean lightness value is equal to or more than the threshold, in step S704, the region integration unit 230 determines that the region selected in step S701 is a candidate of the specular reflected light region. Then, the processing proceeds to step S705. In step S705, the region integration unit 230 determines whether all regions have been selected and processed. If there is an unprocessed region, the processing returns to step S701 and is repeated. If such processing is performed, in the example of FIG. 5C, the region of the cluster 504 is determined to be the candidate of the specular reflected light region.

Returning to FIG. 6 to continue the explanation, in step S602, the region integration unit 230 determines whether there is the candidate of the specular reflected light region from the result of the processing in step S601. If there is the candidate of the specular reflected light region, the processing proceeds to step S603. If there is no candidate, the processing of FIG. 6 is terminated. At this point, the candidate of the specular reflected light region is extracted merely based on whether the mean lightness value is equal to or more than the threshold or not. Accordingly, there are cases where the specular reflected light region is appropriately extracted as the candidate and cases where a region which is not the specular reflected light region is extracted as a candidate. For example, there is a case where an object has a pattern including a dark portion and a bright portion with lightness higher than the threshold, and a region of the bright portion is extracted as a candidate of the specular reflected light region. Moreover, there is a case where an object with higher lightness than the threshold overlaps a dark object. In a case where the original lightness of the object (or part of the object) is equal to or greater than the threshold as described above, a region of this object may be extracted as the candidate of the specular reflected light region, although the region is not the specular reflected light region. In other words, the candidate extracted based on the mean lightness value and the threshold may be or may not be the specular reflected light region. Thus, processing of specifying the specular reflected light region from the candidates of the specular reflected light region is performed as described below. Hereafter, the candidates of the specular reflected light region is referred to as candidate regions.

In step S603, the region integration unit 230 selects one of the candidate regions extracted in step S601. In step S604, the region integration unit 230 selects an adjacent region which is adjacent to the candidate region selected in step S603. For example, in the example of FIG. 5C, the cluster 505 adjacent to the cluster 504 which is the candidate region is selected as the adjacent region.

In step S605, the region integration unit 230 performs processing of determining whether there is a flare characteristic in a border portion between the candidate region selected in step S603 and the adjacent region selected in step S604. The flare characteristic is gradation which appears at a border between the specular reflected light and the diffuse-reflected light. In a case where the flare characteristic appears, the region integration unit 230 can determine that the candidate region is the specular reflected light region. Meanwhile, if no flare characteristic appears, the region integration unit 230 can determine that the candidate region is, for example, an object which is originally bright, a region where a bright portion of a pattern is extracted, or the like as described above and is not the specular reflected light region.

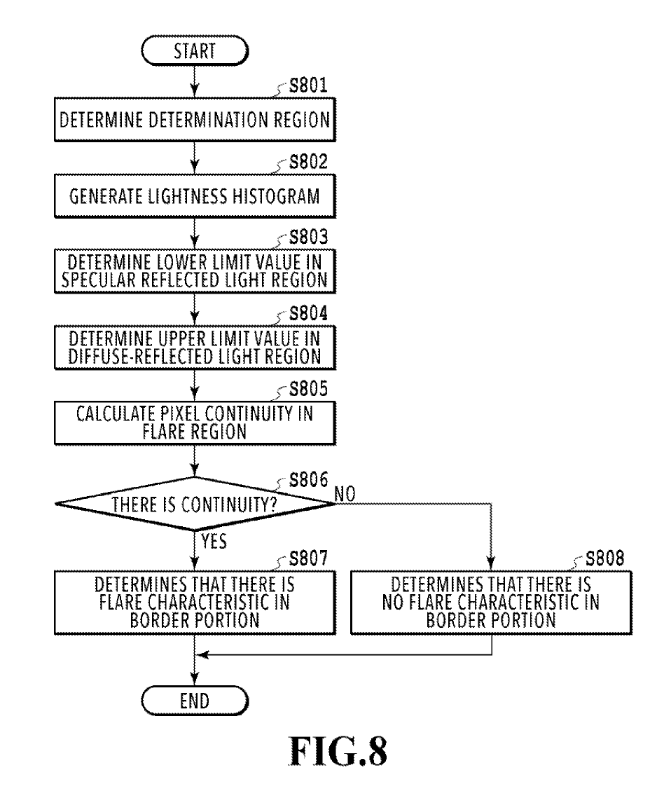

FIG. 8 is a flowchart for explaining details of determination processing of the flare characteristic in step S604. A determination method of the flare characteristic (gradation) is described by using the flowchart of FIG. 8.

In step S801, the region integration unit 230 determines a region in which the determination of flare characteristic is to be performed. The flare characteristic may be included in the specular reflected light region or in the diffuse-reflected light region among the segmentation regions, depending on the method of region segmentation and the object or the like in the image. In either case, the flare characteristic appears in the border portion between the specular reflected light and the diffuse-reflected light. Accordingly, in step S801, a region obtained by expanding the candidate region selected in step S603 toward the adjacent region by a predetermined distance is determined to be the region in which the determination of flare characteristic is to be performed.

A region 540 surrounded by the broken line in FIG. 5E illustrates an example of the determination region for determining whether there is the flare characteristic for the specular reflected light region of the cluster 504 in FIG. 5C. As a method of determining such a determination region, there is selected a range which includes the cluster 504 being the candidate region and further spreads from the border line (broken line) between the cluster 504 and the cluster 505 in FIG. 5C toward the adjacent region to positions a specified number of pixels away from the border line. The specified number of pixels only has to be set, for example, within such a range that the determination region is within the borders of the cluster 505 except for the border with the cluster 504 and a sufficient number of pixels in the cluster 505 can be obtained (for example, 10% or more outside the region of the cluster 504).

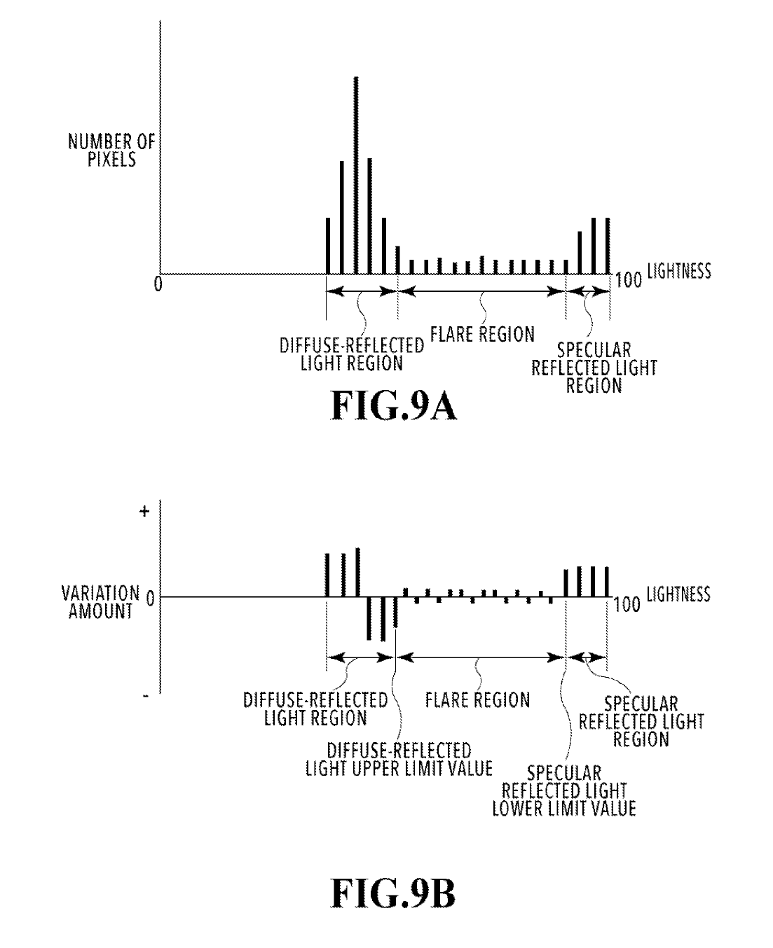

In step S802, the region integration unit 230 obtains distribution of the degrees of lightness in the determination region determined in step S801. In this case, the region integration unit 230 obtains a lightness histogram. FIG. 9A is a view illustrating an example of the lightness histogram. In FIG. 9A, the horizontal axis represents the degree of lightness (CIE L*) of the determination region determined in step S801. The vertical axis represents the number of pixels (appearance frequency). In the example of FIG. 5C, the determination region includes the specular reflected light region (cluster 504) and part of the diffuse-reflected light region (cluster 505). Accordingly, two peaks are formed in the lightness histogram.

In step S803, the region integration unit 230 determines a lightness lower limit value in the candidate region (candidate of the specular reflected light region) selected in step S603. In the determination of the lightness lower limit value, for example, a degree of lightness about 10% lower than the highest degree of lightness in the lightness histogram of FIG. 9A is set as the lower limit value. Specifically, as described above, a value obtained by multiplying the highest lightness value by the predetermined coefficient α as described in the formula 1 can be set as the lightness lower limit value. In FIG. 9A, since the highest degree of lightness is 100, if α=0.9, the lightness lower limit value in the candidate region is 90.

In step S804, the region integration unit 230 determines a lightness upper limit value in the adjacent region (that is, the diffuse-reflected light region) selected in step S604. FIG. 9B illustrates a variation amount in the histogram of FIG. 9A. In FIG. 9B, in a portion corresponding to the diffuse-reflected light region (on the low lightness side), the variation amount changes from a positive value to a negative value and then from a negative value to a positive value, and the lightness upper limit value in the adjacent region (diffuse-reflected light region) is set to a lightness value at the point where the variation amount changes from a negative value to a positive value.

In step S805, the region integration unit 230 checks continuity in a flare region. For example, in FIG. 9A, the region integration unit 230 checks continuity of pixels (flare regions) with degrees of lightness between the lightness upper limit value determined in step S803 and the lightness lower limit value determined in step S804. Regarding the method of checking the continuity, the continuity can be checked by, for example, checking whether pixels of all degrees of lightness from the lightness upper limit value to the lightness lower limit value are present or pixels are present in all lightness classification divisions (bins) from the lightness upper limit value to the lightness lower limit value. If the candidate region selected in step S603 is not the specular reflected light region and is, for example, an object which is originally bright, there is no continuity of the pixels between the lightness upper limit value and the lightness lower limit value. In other words, there is no gradation. Meanwhile, if a flare is formed, as illustrated in FIG. 9A, there is the continuity of the pixels (there is gradation).

In step S806, the region integration unit 230 determines whether there is the continuity of the pixels between the lightness upper limit value and the lightness lower limit value in the lightness histogram. If there is the continuity, the processing proceeds to step S807 and the region integration unit 230 determines that there is the flare characteristic in the border portion with the adjacent region. If there is no continuity, the processing proceeds to step S808 and the region integration unit 230 determines that there is no flare characteristic in the border portion with the adjacent region.

Returning to FIG. 6 to continue the explanation of the processing, in step S606, the region integration unit 230 determines whether there is the flare characteristic in the border portion with the adjacent region from the result of step S605. If there is the flare characteristic, the processing proceeds to step S607 and the adjacent region selected in step S604 is added to regions of candidates to be integrated (hereafter, referred to as integration candidates). Then, the processing proceeds to step S608. If there is no flare characteristic, the processing of step S607 is skipped.

In step S608, the region integration unit 230 determines whether all regions adjacent to the candidate region have been selected. If there is an unselected adjacent region, the processing returns to step S604 and is repeated. If all regions are selected, the processing proceeds to step S609. In the example of FIG. 5C, description is given of the example in which there is one adjacent region. However, in some cases, there are multiple adjacent regions.

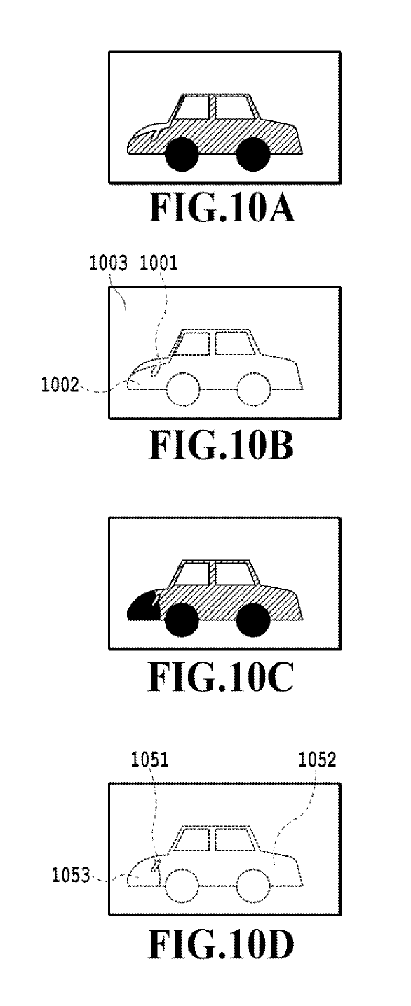

FIG. 10A illustrates an example in which there are multiple regions adjacent to the candidate region. The specular reflected light is captured in a border portion between the vehicle body and the background. Accordingly, as illustrated in FIG. 10B, regions adjacent to a cluster 1001 being the candidate region are a cluster 1002 and a cluster 1003. In the processing of step S605 of FIG. 6, a region obtained by expanding the candidate region toward the adjacent region adjacent to the candidate region is used as the region for the flare determination. Accordingly, in the example of FIG. 10B, in the case where the cluster 1002 is selected as the adjacent region, the flare characteristic appears. Meanwhile, in the case where the cluster 1003 is selected as the adjacent region, no flare characteristic appears. Thus, also in the case where there are multiple adjacent regions, an appropriate region can be added as the integration candidate by performing the flare characteristic determination by using the determination regions expanded toward the adjacent regions.

Returning to FIG. 6 to continue the explanation, if there is the adjacent region added as the integration candidate in step S608, in step S609, the region integration unit 230 integrates the adjacent region with the candidate region selected in step S603. In the case of FIG. 5C, the region integration unit 230 integrates the cluster 504 and the cluster 505. A cluster of pixels in the cluster 504 may be set as the cluster 505 or a cluster of pixels in the cluster 505 may be set as the cluster 504. FIG. 5D is a view illustrating an example of an integration result. It is apparent that the cluster 504 has disappeared in the FIG. 5D. A region including the specular reflected light thus forms one cluster of the object. Accordingly, an appropriate determination result can be obtained in the determination of the gloss using the dichromatic reflection model.

Note that, in some cases, there are multiple integration candidates added in step S608. The case where there are multiple integration candidates is described below. FIG. 10C illustrates an example in which the object (vehicle body) has a pattern and illustrates an image in which the specular reflected light is captured at the same position as that in FIG. 5A. In a case where the region segmentation processing is performed on the image of FIG. 10C, as illustrated in FIG. 10D, the object region is segmented into a cluster 1052 and a cluster 1053 due to an effect of the pattern. In this case, if the specular reflected light region (cluster 1051) extends across the cluster 1052 and the cluster 1053 as illustrated in FIG. 10D, accurate gloss determination cannot be performed in the subsequent processing. This because the original lightness of the cluster 1052 varies from that of the cluster 1053 and thus the gloss determination using the skewness of the lightness cannot be appropriately performed. Accordingly, in the case where there are multiple integration candidates, the integration processing does not have to be performed. Note that, in the case where the lightness of the cluster 1052 is sufficiently close to that of the cluster 1053, the clusters 1051 to 1053 may be integrated.

Returning to FIG. 6 to continue the explanation, in step S610, the region integration unit 230 determines whether all candidate regions extracted in step S601 have been selected. If there is an unselected candidate, the processing returns to step S603 and is repeated. If all candidates have been selected, the processing of FIG. 6 is terminated.

As described above, in the embodiment, appropriate gloss determination can be performed also in the case where an image is segmented into the specular reflected light region and the diffuse-reflected light region as separate regions as a result of the region segmentation processing. Specifically, appropriate gloss determination can be performed by integrating the specular reflected light region and the diffuse-reflected light region and performing the gloss determination by using the integrated region.

Moreover, in the embodiment, in the case of determining whether there is the flare characteristic in the border portion between the candidate region and the adjacent region, the determination region is determined and the determination of the flare characteristic is performed based on the lightness histogram of the determination region. In such processing, arrangement relationships of actual pixels between the candidate region and the adjacent region are not used as determination factors. Accordingly, the processing can be performed at high speed.

### Embodiment 2

In Embodiment 2, description is given of an example in which the processing of determining the flare characteristic in the border portion with the adjacent region is different from that described in step S605 of FIG. 6. In Embodiment 1, the arrangement relationships of the actual pixels are not used as the determination factors, and the processing can be thus performed at high speed. However, there is a possibility of erroneous determination depending on an image of a certain condition. For example, in the case where image regions of half tone are discretely included in the determination region described in Embodiment 1 due to noise or the like, the result of the lightness histogram may be the same as the flare characteristic. In other words, although there is no flare characteristic, the region integration unit 230 may determine that there is the flare characteristic. In the embodiment, description is given of the mode in which the determination of flare characteristic is performed more accurately by using the arrangement relationships of the actual pixels as the determination factors. Hereafter, differences from Embodiment 1 are mainly described.

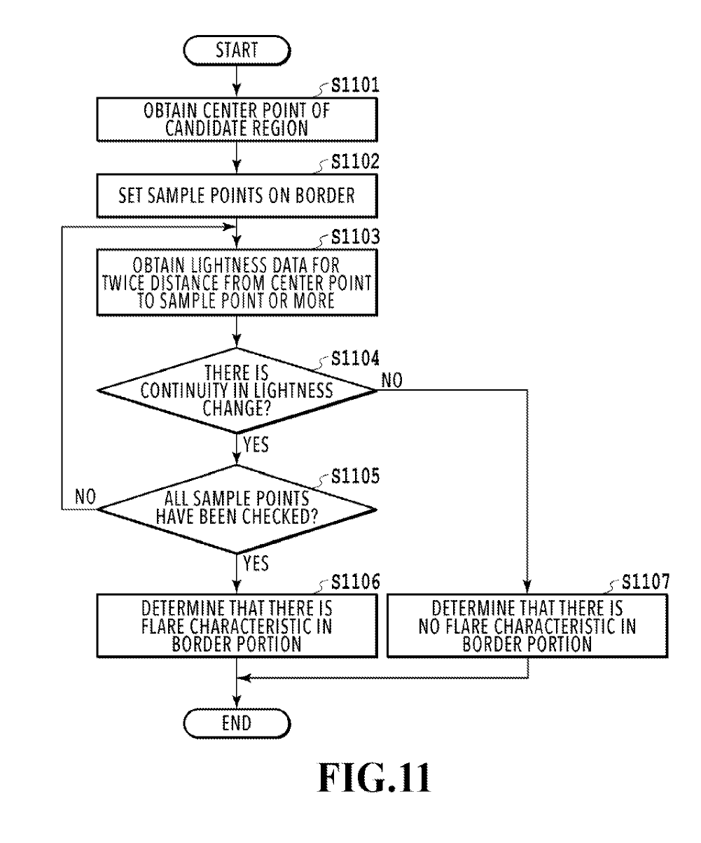

FIG. 11 is a detailed flowchart of the determination processing of the flare characteristic in the border portion with the adjacent region in step S605 in Embodiment 2.

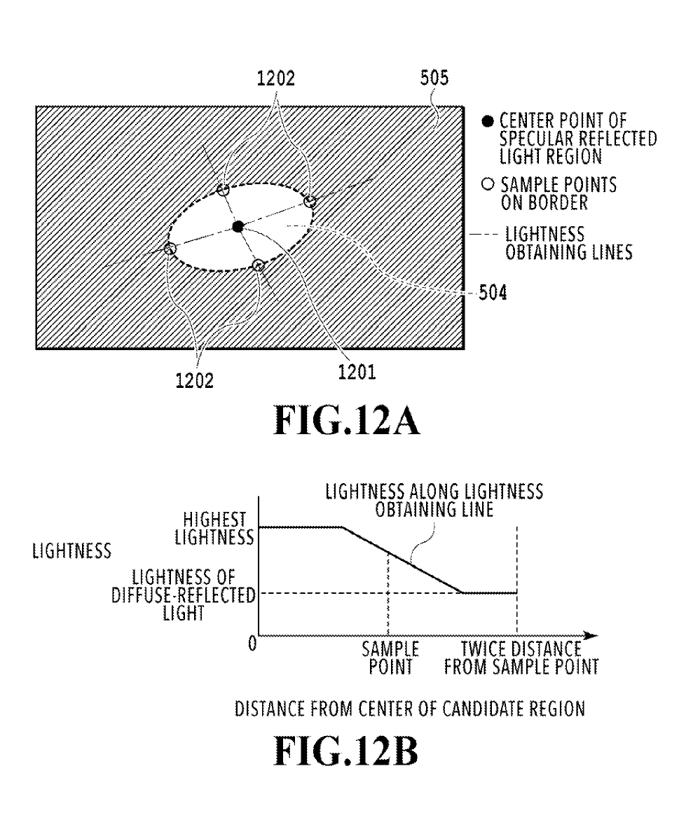

In step S1101, the region integration unit 230 obtains the coordinates of the center point of the candidate region (cluster 504 in FIG. 5) selected in step S603. As a method of obtaining the coordinates of the center point, a method of obtaining the coordinate averages of all pixels in the cluster 504 can be used to obtain the coordinates of the center point. FIG. 12A is an enlarged view of the cluster 504 (candidate region) of FIG. 5C and the cluster 505 (adjacent region) surrounding the cluster 504. In FIG. 12A, the center point 1201 of the candidate region (candidate of the specular reflected light region) is illustrated. The dotted line in FIG. 12A illustrates the border between the cluster 504 and the cluster 505.

In step S1102, the region integration unit 230 sets sample points on the border with the adjacent region selected in step S604. The number of sample points may be any number which is one or more. In a case where multiple sample points are to be set, the coordinates of the sample points are preferably set away from each other but may be close to each other. In FIG. 12A, four sample points 1202 are illustrated on the border. In this processing, the sample points are set on the border with the adjacent region selected in step S604. FIG. 12A illustrates the example in which the cluster 505 is the only adjacent region adjacent to the cluster 504 (candidate region). Meanwhile, in the case where there are multiple adjacent regions, the sample points are set on the border with the adjacent region selected in step S604. Specifically, no sample points are set on the border with the adjacent regions not selected in step S604 among the multiple adjacent regions.

In step S1103, the region integration unit 230 obtains lightness data of each pixel on a line which extends from the center point obtained in step S1101, via one of the sample points set in step S1102, to a position (first position) away from the center point by about twice the distance between the center point and the sample point. In FIG. 12A, an imaginary lightness obtaining line is drawn for each of the four sample points 1202. FIG. 12B illustrates the lightness data on one of the lightness obtaining lines illustrated in FIG. 12A. Note that the lightness of pixels at positions across the sample point (that is across the border) is obtained due to the same reason as that described in Embodiment 1. Specifically, the lightness is obtained because the flare characteristic sometimes appears at a position across the border (in the adjacent region). Although the pixels on the line extending to the position away from the center point by about twice the distance between the center point and the sample point are used as the targets for determining the continuity of the lightness change in this example, the targets are not limited to this example. It is only necessary that the continuity of the lightness change from the candidate region to the position across the border with the adjacent region is determined.

In step S1104, the region integration unit 230 determines whether, in a case where there is a change in the lightness, the direction of the change is continuous in one direction. For example, in FIG. 12B, the region integration unit 230 determines whether the condition expressed by the following formula 2 is satisfied by all points (pixels) from the point where the distance from the center of the candidate region is zero to the point where the distance from the center is twice the distance between the center point to the sample point.

−β≤L[x]−L[x+1]≤0 (Formula 2)

In this formula, x is the distance from the center point of the specular reflected light region. β is the largest value of an allowable lightness level difference. Specifically, the aforementioned formula 2 expresses such a condition that the lightness either remains the same or changes within the allowable level difference as the distance from the center of the candidate region increases. In a case where the lightness data satisfies the condition, the region integration unit 230 determines that there is continuity in the lightness change in the one direction from the center of the candidate region toward the outside of the border. Specifically, as described in Embodiment 1, the region integration unit 230 can determine that gradation (flare characteristic) is formed near the border.

If there is continuity, the processing proceeds to step S1105. If not, the processing proceeds to step S1107 and, in step S1107, the region integration unit 230 determines that there is no flare characteristic in the border portion. In step S1105, the region integration unit 230 determines whether the continuity has been checked for all sample points set in step S1102. If there is a sample point for which the continuity has not been checked, the processing returns to step S1103 and is repeated. If the check is completed for all sample points, the processing proceeds to step S1106 and the region integration unit 230 determines that there is the flare characteristic in the border portion.

As described above, in the embodiment, the determination processing of the flare characteristic is performed by using the arrangement relationships of the actual pixels as the determination factors. Accordingly, the determination of the flare characteristic can be performed more accurately.

### Other Embodiments

Although the modes of printing images are described as examples in the aforementioned embodiments, the present invention is not limited to these modes. The present invention may be applied to modes of displaying images. For example, in the case where an image is to be displayed on a display, the glossiness can be improved by performing high dynamic range (HDR) processing depending on the result of the gloss determination.

Although the bitmap image obtained by analyzing the PDL data has been described as the example of the image data, the image data is not limited to this and any form of image data can be used.

Although the modes in which the SLIC processing is used as the region segmentation processing are described as the examples, the present invention is not limited to this. For example, a method of segmenting the region depending on a predetermined threshold by using a histogram may be used. Moreover, a method of extracting edges in the image and segmenting the region based on the continuity or the like of the edges may be used. Since the segmentation of the region is performed based on the pixel values (or the lightness values obtained by lightness conversion) of the image in either mode, there is a possibility that the specular reflected light region and the diffuse-reflected light region are handled as separate regions although they belong to the same object. The aforementioned embodiments can be applied to regions obtained by segmentation processing other than the SLIC processing.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, the degree of gloss of an object can be appropriately determined in the case where a region of the object is segmented into the specular reflected light region and the diffuse-reflected light region as a result of the region segmentation processing.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-026814, filed Feb. 19, 2018, which is hereby incorporated by reference wherein in its entirety.

What is claimed is:

1. An image processing apparatus comprising:
a memory device that stores a set of instructions; and
at least one processor that executes the set of instructions to:
obtain an image;
segment the obtained image into regions; and
integrate a specular reflected light region and an adjacent region adjacent to the specular reflected light region among the segmented regions into an integrated region; and
determine glossiness of each of the regions including the integrated region.

2. The image processing apparatus according to claim 1, wherein the integration includes
determining whether there is a flare characteristic near a border between the specular reflected light region and the adjacent region, wherein
in a case where there is the flare characteristic, the specular reflected light region and the adjacent region are integrated.

3. The image processing apparatus according to claim 1, wherein the integration includes
determining whether there is a flare characteristic near a border between the specular reflected light region and the adjacent region, wherein
in the case where there is no flare characteristic, the integration of the specular reflected light region and the adjacent region is canceled.

4. The image processing apparatus according to claim 2, wherein the integration includes performing the determination of the flare characteristic based on distribution of lightness in a determination region obtained by expanding the specular reflected light region toward the adjacent region.

5. The image processing apparatus according to claim 4, wherein the integration includes determining that there is the flare characteristic in the case where gradation appears in the distribution of the lightness.

6. The image processing apparatus according to claim 2, wherein the integration includes performing the determination of the flare characteristic based on distribution of lightness of pixels on a line from a center point of the specular reflected light region to a first position across a point on the border between the specular reflected light region and the adjacent region.

7. The image processing apparatus according to claim 6, wherein the integration includes determining that there is the flare characteristic in the case where there is a change in the lightness from the center point toward the first position and a direction of the change is one direction.

8. The image processing apparatus according to claim 1 wherein the integration includes determining the specular reflected light region from the segmented regions based on a highest lightness value in the obtained image.

9. The image processing apparatus according to claim 1, wherein the integration includes, in the case where there are a plurality of the adjacent regions, canceling the integration of the specular reflected light region and the adjacent regions.

10. The image processing apparatus according to claim 1, wherein the determination includes determining glossiness of each of the regions based on skewness of lightness in the region.

11. The image processing apparatus according to claim 1, wherein the at least one processor executes instructions in the memory device to perform image processing relating to gloss based on a determination result obtained in the determination.

12. An image processing method comprising the steps of:
obtaining an image;
segmenting the obtained image into regions;
integrating a specular reflected light region and an adjacent region adjacent to the specular reflected light region among the segmented regions into an integrated region; and
determining glossiness of each of the regions including the integrated region.

13. A non-transitory computer readable storage medium storing a program which performs an image processing method, wherein the image processing method includes the steps of:
obtaining an image;
segmenting the obtained image into regions;
integrating a specular reflected light region and an adjacent region adjacent to the specular reflected light region among the segmented regions into an integrated region; and
determining glossiness of each of the regions including the integrated region.
